(19) United States
(12) Patent Application Publication
(10) Pub. No.: US 2025/0262836 A1
(43) Pub. Date: Aug. 21, 2025

(54) HIGH-TEMPERATURE OIL AND OZONE-RESISTANT BONDED COVER LAYER FOR MULTILAYER HOSE

(71) Applicant: ContiTech Deutschland GmbH, Hannover (DE)

(72) Inventor: Guangzhuo Rong, Hudson, OH (US)

(73) Assignee: ContiTech Deutschland GmbH, Hannover (DE)

(21) Appl. No.: 18/583,552

(22) Filed: Feb. 21, 2024

(51) Int. Cl. B32B 1/08; B32B 25/08; B32B 25/14; B32B 25/16; B32B 37/00; B32B 38/00; B32B 38/18

(52) U.S. Cl. CPC B32B 1/08; B32B 25/08; B32B 25/14; B32B 25/16; B32B 37/156; B32B 38/1841; B32B 2038/0076; B32B 2305/08; B32B 2305/72; B32B 2307/54; B32B 2319/00; B32B 2363/00; B32B 2597/00

(57) ABSTRACT

An article such as a multilayer hose including an a polyacrylic elastomer (ACM) layer directly bonded to an epichlorohydrin elastomer (ECO) layer without an intervening adhesive layer. The ACM layer is formed from an ACM-based elastomeric composition including at least one polymer having one or more acrylate monomer(s), in which the at least one polymer includes chlorine cure-sites; and a triazine cure system that vulcanizes the ACM-based composition via at least the chlorine cure-sites. The ECO layer is formed from an ECO-based elastomeric composition including at least one polymer having epichlorohydrin monomer, in which the at least one polymer includes chlorine cure-sites; and a triazine cure system that vulcanizes the ECO-based composition via at least the chlorine cure-sites. The ACM layer and the ECO layer are directly bonded together by co-vulcanization with the triazine cure systems activating at least the chlorine cure-sites of the ACM-based and ECO-based elastomeric compositions.

### TECHNICAL FIELD

The present disclosure generally relates to a multilayer elastomeric article, and more particularly to a multilayer hose having a high-temperature oil and/or ozone-resistant bonded cover layer.

### BACKGROUND

Multilayer hoses are used in a wide variety of applications for transporting fluids. For example, one common application of a multilayer hose is as an asphalt and bitumen transfer hose that is used to transfer high temperature petroleum-based materials such as tar, asphalt and hot oils having a temperature of about 200° F. to 400° F. These hoses generally are suitable for suction and discharge service on tank trucks, tank cars, or at bulk stations such as docks. Generally, such hoses should be strong, durable, flexible, ozone-resistant, and have high-temperature resistance and chemical resistance to the operating fluids being transferred. Such hoses also should be capable of being coupled to fittings in a manner that prevents the fluid from escaping. The standard specifications for such hoses are described in DIN EN 13482:2013.

One conventional approach for an asphalt and bitumen transfer hose is to provide at least an inner tube of oil-resistant nitrile elastomeric material (NBR), a reinforcement layer outward of the inner tube, and an elastomeric cover layer outward of the reinforcement layer. The DIN EN 13482:2013 standard states that the cover layer compound of the hose should have good ozone resistance and also pass 168 hours of oil immersion at 200° C. (392° F.) in a medium of PmB-bitumen 25 (55-55A). Although the NBR inner tube generally has good heat resistance and chemical resistance to oil, it generally lacks adequate ozone resistance. As such, conventional cover layer compounds used on current hose products are often based on hydrogenated nitrile butadiene rubber (HNBR).

### SUMMARY

There is a need in the market for hoses, and elastomeric articles in general, to replace HNBR with another type of material that can satisfy the ozone, chemical and/or temperature resistant properties required for the application while also being compatible with other layer(s) of the article.

At least one aspect of the present disclosure solves one or more problems associated with conventional elastomeric articles having an HBNR layer by providing a unique combination layer solution for replacing HNBR in which the combined layers are directly bonded together without an intervening adhesive layer.

More particularly, an aspect of the present disclosure provides an article having a high-temperature, ozone-resistant, oil-resistant polyacrylic elastomer (ACM) layer and an adjacent epichlorohydrin elastomer (ECO) layer that are each specially formulated to provide direct bonding to each other without an intervening adhesive layer.

For example, the ACM layer and ECO layer may each be formulated to have polymer(s) with chlorine cure sites and a suitable cure system such as triazine that can co-cure the layers together and form the direct bond.

Such direct bonding can obviate problems associated with adhesive layers, such as the release of volatile organic compounds which can become trapped as bubbles between layers and/or which can be applied inconsistently, each of which can result in spotty adhesion between layers.

In exemplary embodiments, the direct bonding performance between the ACM layer and the ECO layer may be characterized by an average load per width of 30 lbf/in or greater according to ASTM D413-98. Such bonding performance may make these layers particularly suitable for articles such as hose.

To further enhance the compatibility and bondability between the ACM and ECO layers, these layers also may be formulated to have the same or similar plasticizer(s).

In exemplary embodiments, the polyacrylic elastomer (ACM) layer forms an outer layer of the article, such as a cover layer of a hose, and the adjacent epichlorohydrin elastomer (ECO) layer forms an intermediate layer that can promote direct bonding to a further layer of the article.

More particularly, the ECO layer may include base polymer(s) having dual cure-site functionality to promote direct bonding to the ACM layer on one side of the ECO layer and direct bonding to another elastomeric layer on the opposite side of the ECO layer.

For example, the ECO layer may include the chlorine cure sites that promote direct bonding to the ACM layer via the triazine cure system, and also may include sulfur cure sites that promote direct bonding to a sulfur-curable elastomeric material via a sulfur cure system.

In exemplary embodiments, the additional elastomeric layer is a nitrile butadiene elastomer (NBR) layer having sulfur cure sites and a sulfur cure system that provide direct bonding to the ECO layer via the sulfur cure sites in the ECO layer.

Such a three-layer combination with the ECO layer having dual-cure site functionality can enable all three layers to be directly bonded via co-vulcanization of the ECO layer, the sulfur-curable (NBR) layer and the ACM layer via their respective cure systems.

In addition, the sulfur-curable (NBR) layer may promote yet further direct bonding to an additional layer of the article, such as to a further elastomeric layer (e.g., NBR-based), or to a reinforcement layer of the article, such as a direct bond to a coated reinforcement fabric.

Such a multilayer solution with direct bonding between multiple layers including a reinforcement layer may be particularly suitable for an article such as a hose, and more particularly an asphalt and bitumen transfer hose in which the ACM outer cover layer can provide the ozone, chemical and temperature resistant properties that satisfy the specifications of the DIN EN 13482:2013 standard, and in which the additional layers also help satisfy the specifications for such hose.

According to at least one aspect, a multilayer hose includes: a polyacrylic elastomer (ACM) layer directly bonded to an epichlorohydrin elastomer (ECO) layer without an intervening adhesive layer, the ACM elastomer layer being formed from an ACM-based elastomeric composition including: at least one polymer having one or more acrylate monomer(s), in which the at least one polymer includes chlorine cure-sites; and a triazine cure system that vulcanizes the ACM-based elastomeric composition via at least the chlorine cure-sites; the ECO elastomeric layer being formed from an ECO-based elastomeric composition including: at least one polymer having epichlorohydrin monomer, in which the at least one polymer includes chlorine cure-sites; and a triazine cure system that vulcanizes the ECO-based elastomeric composition via at least the chlorine cure-sites; wherein the ACM layer and the ECO layer are directly bonded together by co-vulcanization with the triazine cure systems activating at least the chlorine cure-sites of the ACM-based and ECO-based elastomeric compositions.

According to another aspect, a multilayer hose includes: an inner tube layer, a reinforcement layer including reinforcement strands disposed outwardly of the inner tube layer, a nitrile butadiene elastomer (NBR) layer bonded to the reinforcement strands, the NBR layer being formed from an NBR-based elastomeric composition including (i) one or more polymer(s) having acrylonitrile monomer and butadiene monomer; and (ii) a sulfur cure system; an epichlorohydrin elastomer (ECO) layer directly bonded to the NBR layer without an intervening adhesive layer, the ECO elastomeric layer being formed from an ECO-based elastomeric composition including: (i) at least one polymer including epichlorohydrin monomer, in which the at least one polymer includes chlorine cure-sites and sulfur cure sites; and (ii) a triazine cure system that vulcanizes the ECO-based elastomeric composition via at least the chlorine cure-sites; and a polyacrylic elastomer (ACM) layer directly bonded to the ECO layer without an intervening adhesive layer, the ACM elastomer layer being formed from an ACM-based elastomeric composition including: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites; wherein co-vulcanization of the respective elastomeric compositions of the NBR layer, the ECO layer, and the ACM layer with their respective cure systems forms direct bonding between the NBR, ECO and ACM layers.

A method of manufacturing a multilayer hose, including: applying a first elastomeric composition for forming an inner tube of the hose; applying reinforcement including reinforcement strands around the first elastomeric composition for forming at least part of a reinforcement layer; applying a second elastomeric composition for forming an intermediate layer around the reinforcement, wherein the second elastomeric composition is an epichlorohydrin elastomer (ECO) based elastomeric composition including: (i) at least one polymer including epichlorohydrin monomer, in which the at least one polymer includes chlorine cure-sites; and (ii) a triazine cure system that vulcanizes the ECO-based elastomeric composition via at least the chlorine cure-sites; applying a third elastomeric composition for forming a cover layer around the intermediate layer, wherein the third elastomeric composition is a polyacrylic elastomer (ACM) based elastomeric composition including: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites; and co-vulcanizing the first, second, and third elastomeric compositions, wherein the co-vulcanizing activates at least the chlorine cure sites with the triazine cure systems of the ACM-based and ECO-based elastomeric compositions and directly bonds the intermediate layer and the cover layer together.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various embodiments according to the present disclosure.

FIG. 1 illustrates a multilayer reinforced hose in a cut away perspective view, in accordance with an embodiment of the present disclosure.

FIG. 2 illustrates a cross-section of a multilayer article, in accordance with an embodiment of the present disclosure.

FIG. 3 illustrates a cross-section of another multilayer article, in accordance with an embodiment of the present disclosure.

### DETAILED DESCRIPTION

The principles and aspects of the present disclosure have particular application to hoses, in particular asphalt and bitumen transfer hoses, and thus will be described herein chiefly in this context. It is understood, however, that the principles and aspects of the present disclosure may be applicable to other types of hoses for other applications, or to other articles in general, when desirable to provide one or more advantages of the material(s) and/or construction(s) described herein.

Many conventional articles use hydrogenated nitrile butadiene rubber (HNBR) as the base elastomer for a cover layer compound due to its ozone resistance, high-temperature capabilities and chemical resistance. However, there is a need in the market for elastomeric articles, and hoses in particular, to find a suitable replacement for HNBR materials. More particularly, there is a need to find a replacement material(s) for HNBR that can satisfy DIN EN 13482:2013 specifications for bitumen and asphalt transfer hoses, while also being compatible (e.g., bondable, processable, etc.) with other layer(s) of the hose.

An aspect of the present disclosure problems associated with conventional elastomeric articles having an HBNR layer by providing a unique combination layer solution for replacing HNBR in which the combined layers are directly bonded together without an intervening adhesive layer. More particularly, an aspect of the present disclosure provides an article having an ozone-resistant, high-temperature, oil-resistant polyacrylic elastomer (ACM) layer and an adjacent epichlorohydrin elastomer (ECO) layer that are each specially formulated to provide direct bonding to each other without an intervening adhesive layer. Such a multilayer solution with direct bonding between multiple layers may be particularly suitable for an article such as a hose, and more particularly an asphalt and bitumen transfer hose in which the ACM outer cover layer can provide the ozone, chemical and temperature resistant properties that satisfy the specifications of the DIN EN 13482:2013 standard.

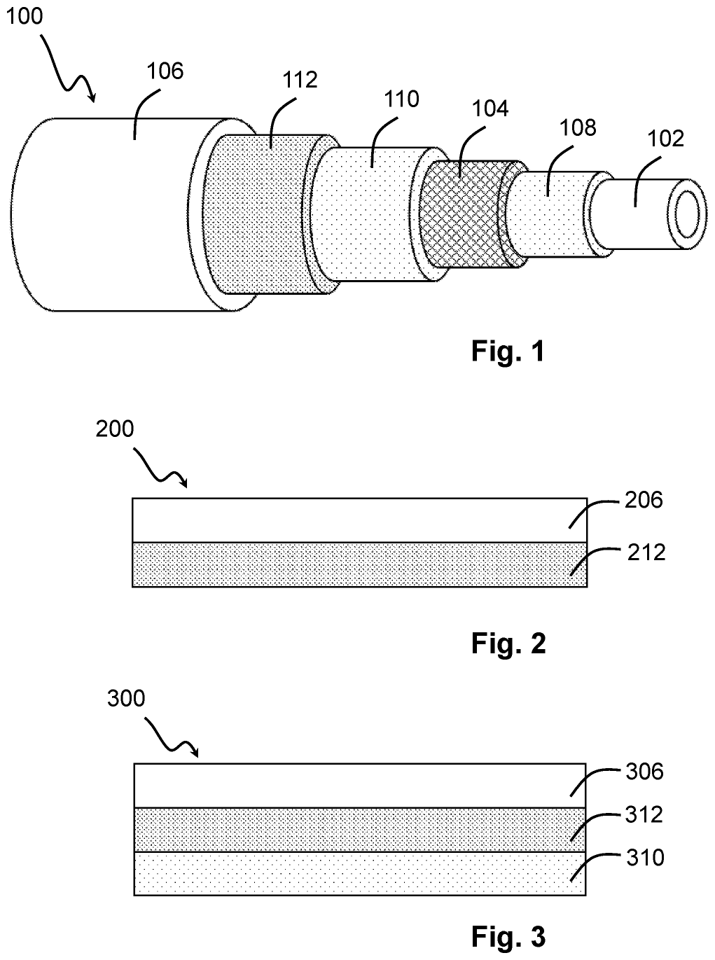

Turning to FIG. 1, an article in the form of an exemplary multilayer hose 100 is shown. The hose 100 may be configured for use as an asphalt and bitumen transfer hose and includes an inner tube 102, a reinforcement layer 104 outwardly of the inner tube 102, and a cover layer 106 outwardly of the reinforcement layer 104. To enable direct bonding between layers without an adhesive, as described in further detail below, the exemplary hose 100 also may include one or more of a first (inner) intermediate layer 108 between the inner tube and the reinforcement layer 104, a second (outer) intermediate layer 110 outwardly of the reinforcement layer 104, and a third (outer) intermediate layer 112 outwardly of the second intermediate layer 110 and inwardly of the cover layer 106. Such layers may be directly adjacent to and in direct contact with each other without further intervening layers, as shown. It is understood, however, that for some hoses in some applications, additional layers or fewer layers may be provided in the article, as would be understood by those skilled in the art.

The hose 100 designed as an asphalt and bitumen hose may have different constructions based on the application. For example, according to DIN EN 13482:2013 standard, the hose 100 may have an inner diameter from 50 mm to 203 mm. The working pressure of such a hose may be up to about 15 bar. The operating temperature may be up to 200° C. The hose may have a bend radius in a range from about 275 mm to about 1269 mm, depending on its inner and outer diameter size. The coupling may be a built-in coupling with flange, swaged-on, or clamped-on after manufacture of the hose.

The overall wall thickness of the hose and the thickness of the individual layers also may be based on the type of hose and its application. For example, the wall thickness of the inner tube 102 may be in a range from about 0.08 inch (2 mm) to about 0.16 inch (4 mm), the wall thickness of the intermediate layers 108, 110 may be in range from about 0.02 inch (0.5 mm) to about 0.05 inch (1.3 mm), the wall thickness of the intermediate layer 112 may be in range from about 0.02 inch (0.5 mm) to about 0.05 inch (1.3 mm), and the wall thickness of the cover layer 106 may be in a range from about 0.04 inches (1 mm) to about 0.12 inches (3.0 mm).

In exemplary embodiments, to provide suitable properties and direct bonding between adjacent layers, the exemplary hose 100 is constructed with the cover layer 106 as a polyacrylic elastomer (ACM) layer and the third intermediate layer 112 as an epichlorohydrin elastomer (ECO) layer. The ACM layer 106 and ECO layer 112 are each specially formulated to provide direct bonding to each other without an intervening adhesive layer; for example, the ACM layer and the ECO layer may each be formulated to have polymer(s) with chlorine cure sites and a suitable cure system such as triazine that can co-cure the layers together and form the direct bond. The ACM cover layer 106 can provide the ozone, chemical and temperature resistant properties that satisfy the specifications of the DIN EN 13482:2013 standard, and the additional hose layers can also help satisfy the specifications for such asphalt/bitumen transfer hose.

The ECO intermediate layer 112 can also promote direct bonding to a further adjacent layer by providing the ECO layer with base polymer(s) having dual cure-site functionality that promote direct bonding to the ACM layer 106 on one side of the ECO layer 112 and direct bonding to the second intermediate layer 110 on the opposite side of the ECO layer 112. For example, the ECO layer 112 may include the chlorine cure sites that promote direct bonding to the ACM layer 106 via the triazine cure system, and also may include sulfur cure sites that promote direct bonding to a sulfur-curable elastomeric material of the layer 110 via a sulfur cure system. In exemplary embodiments, the second elastomeric intermediate layer 110 is a nitrile butadiene elastomer (NBR) layer having sulfur cure sites and a sulfur cure system that provide direct bonding to the ECO layer 112 via the additional sulfur cure sites in the ECO layer.

Such a layer combination with the ECO layer having dual-cure site functionality can enable all three layers 106, 110, 112 to be directly bonded via co-vulcanization of the ECO layer 112, the sulfur-curable (NBR) layer 110 and the ACM layer 106 via their respective cure systems. The sulfur-curable (NBR) intermediate layer 110 may promote yet further direct bonding to the reinforcement layer 104 via the cure system and material of the reinforcement.

In exemplary embodiments, all layers of the hose 100 are directly bonded together without an intervening adhesive layer (e.g., solvent-base) being applied, in which the hose satisfies all specifications of the DIN EN 13482:2013 standard while eliminating the use of HNBR.

The features and exemplary compositions for each of these layers of the hose 100 will be described in further detail below.

### ACM Cover Layer

The cover layer 106 is a polyacrylic elastomer (ACM) layer formed from an ACM-based elastomeric composition. The ACM-based elastomeric composition includes at least one ACM base polymer and one or more additives, each of which may be of any suitable type and provided in any suitable amount to form the cover layer 106, particularly with properties that satisfy the specifications of DIN EN 13482:2013. The polymer matrix of the elastomeric composition is formed from the ACM polymer(s), and optionally other polymer(s), to serve as the base of the composition. As such, the total polymer content forming the base composition (including mixtures of base polymers) is set at 100 phr. The additives are compounded relative to the total base polymer content of the composition, and as such may be represented in parts per hundred (phr), which means parts per 100 parts of the base polymer(s). The elastomeric composition based on ACM (or the ACM-based elastomeric composition) means that a large majority (e.g., 75% or greater of the polymer matrix is formed from one or more ACM polymers as opposed to other types of base polymers. In exemplary embodiments, the ACM polymer(s) constitute at least 90% by weight, more particularly at least 95%, at least 99%, or essentially 100% by weight (i.e., 100 phr) of the base polymer matrix of the ACM cover layer.

The ACM base polymer(s) of the cover layer 106 include one or more acrylate monomer(s). Generally, the ACM polymer may be a copolymer or terpolymer of ethyl acrylate and other acrylate(s), with a small amount of a vulcanization-supporting monomer(s). Examples of such other acrylate monomers may include, for example, butyl acrylate (BA) and methoxyethyl acrylate (MEA). The vulcanization-supporting monomer(s) (or active crosslinking monomer(s)) provides the active sites for crosslinking. Examples of such active crosslinking monomers may include 2-chlorovinyl ether, vinyl chloroacetate, allyl glycidyl ether and glycidyl methacrylate.

In exemplary embodiments, the ACM polymer(s) include chlorine cure sites which provides for excellent heat, oil, and ozone resistance when cured. The chlorine cure site also may improve bonding to adjacent layers of the article, such as intermediate layer 112, during co-vulcanization, as described in further detail below. An exemplary chlorine cure site monomer for the ACM polymer(s) may be vinyl chloroacetate, which may be provided in an amount between about 1% and about 5% by weight of the ACM polymer and in which the backbone monomer may account for about 95% to about 99% of the polymer weight. Suitable examples of such chlorine cure-site ACM polymer(s) include HyTemp AR71, HyTemp AR71L, HyTemp AR715, HyTemp AR72LF and HyTemp AR74 by Zeon Chemicals.

The ACM-based elastomeric composition also includes one or more reinforcing agents or reinforcing fillers to enhance specific characteristics, such as the mechanical properties of the elastomeric composition. The reinforcing filler(s) may include, for example, one or more carbon blacks, silicas, calcium carbonates (chalk), clays (kaolin), aluminum silicates, calcium silicates, magnesium silicates (talc), or other minerals, or mixtures thereof.

In exemplary embodiments, the ACM-based elastomeric composition contains one or more different types of the reinforcing agent(s) in a total amount from about 20 phr to about 100 phr, more particularly from about 40 phr to about 80 phr, more particularly from about 50 phr to about 70 phr, such as about 20, 30, 40, 50, 60, 70, 80, 90, or 100 phr. If too much total reinforcing agent is present, such as greater than the above-identified range(s), the elastomeric composition may become excessively stiff and less elastic, leading to a reduction in flexibility and elongation at break. If too little total reinforcing agent is added, such as below the above-identified range(s), the reinforcing effect may not be sufficient, leading to weaker mechanical properties of the composition.

In certain embodiments, the ACM-based elastomeric composition contains one or more carbon black(s) as a reinforcing agent. Typically, carbon blacks use a naming convention as specified by ASTM D1765 to identify the particular type and size of the carbon black. For N-series carbon blacks, grades range from N110 to N990, in which the first numerical digit designates a size or surface area of the carbon black, and the last two numerical digits designate the structural complexity of the carbon black. A lower first digit (e.g., N100-series) has a smaller particle size, and thus higher surface area, than a higher first digit (e.g., N900-series). Unlike virgin carbon black, recovered carbon black (rCB) does not use the same N-number designation system according to ASTM D1765; however, the rCB still may have at least an equivalent mean particle size as N-series designated virgin carbon black, and thus any designation of an N-type carbon black as used herein encompasses both virgin and other types of equivalent carbon black (e.g., rCB) unless specifically stated otherwise.

In exemplary embodiments, the ACM-based elastomeric composition contains carbon black(s) in a range between N300-series (e.g., N₂ surface area of about 70-99 m²/g) and N700-series (e.g., N₂ surface area of about 21-32 m²/g). In certain embodiments, the composition includes only one type of carbon black, such as N300-series; for example, N330 carbon black, which may be present in the above-identified range(s).

The ACM-based elastomeric composition also may include one or more plasticizers to increase flexibility, reduce hardness, and improve the processing characteristics of the compound. Examples of plasticizer(s) include ethers, esters, adipates, or the like.

In exemplary embodiments, the chosen plasticizer(s) of the ACM-based composition is/are a non-oil type, which may be particularly suitable for applications where the cover layer is exposed to chemicals such as bitumen. The chosen plasticizer also should be compatible with the base polymer(s) of the elastomeric composition. As such, in exemplary embodiments, the ACM-based elastomeric composition is devoid of oil plasticizer. Examples of suitable non-oil type plasticizers for the ACM-based elastomeric composition may include adipate plasticizer(s) (such as polyester adipate, etc.), ethers, esters, mixed ether/ester type plasticizer(s), or the like.

The one or more plasticizers (e.g., adipate and/or ether/ester type) may be present in the ACM-based elastomeric composition in a total amount from about 1 phr to about 20 phr, more particularly from about 1 phr to about 10 phr, such as about 1, 2, 5, 10, 15, or 20 phr. When two or more such plasticizer(s) are used, they may be present in the above-stated ranges or amounts in about equal proportions (e.g., about 1 to 10 phr polyester adipate plasticizer and about 1 to 10 phr of mixed ether/ester type plasticizer, in about equal amounts). If too much total plasticizer is used in the elastomeric composition, such as greater than the above-identified range(s), then the compound may exhibit excessive softening making it difficult to process, may cause dimensional instability, and may have reduced strength. If too little plasticizer is used in the compound, such as less than the above-identified range(s), then the elastomeric composition may be hard, brittle, and/or have reduced flexibility.

The ACM-based elastomeric composition also may include one or more processing aids to improve processing flow, dispersion of fillers, etc. Examples of processing aid(s) may include fatty acids (such as stearic acid), aliphatic fatty acid ester blends, fatty acid salts, metallic carboxylate soaps or the like.

The one or more processing aid(s) (e.g., stearic acid and/or aliphatic fatty acid ester blend) may be present in the ACM-based elastomeric composition in a total amount from about 1 phr to about 10 phr, more particularly from about 1 phr to about 7 phr, such as about 1, 2, 5, 7 or 10 phr. When two or more such processing aid(s) are used, they may be present in the above-stated ranges or amounts in about equal proportions.

The ACM-based elastomeric composition also may include one or more antidegradants to protect the compound from degradation caused by exposure to oxygen and/or ozone. One example of a suitable antidegradant may include amine-type antidegrant, such as octylated diphenylamine (ODP). The one or more antidegradant(s) (e.g., amine-type) may be present in the ACM-based elastomeric composition in a total amount from about 1 phr to about 5 phr, more particularly from about 1 phr to about 3 phr, such as about 1, 2, 3, 4 or 5 phr.

The ACM-based elastomeric composition also may include one or more accelerators and/or one or more retarders to respectively accelerate or retard the cure of the composition. Examples of accelerators(s) may include Dithiocarbamate accelerators, such as Zinc dibenzyldithiocarbamate (ZBEC), Zinc dibutyl dithiocarbamate (ZDBC), Zinc diethyl dithiocarbamate (ZDEC), Zinc dimethyl dithiocarbamate (ZDMC). Such accelerators(s) may be present in the elastomeric composition in a total amount from about 0.5 phr to about 4 phr. Examples of retarders may include sulfonamide(s), such as N-phenyl-N-(trichloromethylsulfenyl)-benzenesulfonamide and weak acids, such as fatty acids. Such retarder(s) may be present in the ACM-based elastomeric composition in a total amount from about 0.1 to about 1 phr.

The ACM-based elastomeric composition also includes one or more suitable curatives, more particularly a cure system that can react with the chlorine cure sites of the ACM polymer(s) of the composition. In exemplary embodiments, the cure system includes a triazine compound for reacting with the chlorine cure sites to vulcanize the composition. Such a triazine compound may be 2,4,6-trimercapto-1,3,5-triazine, for example, which is a chemical compound with the formula C₃H₃N₃S₃. The triazine cure system may be present in the ACM-based elastomeric composition in a total amount from about 0.2 to about 2 phr, such as about 0.5 phr (including all values and ranges therebetween). Such triazine cure can provide the composition with good scorch results without the need for a post-cure.

As noted above, the ACM-based elastomeric composition of the cover layer 106 may have suitable properties for use as the cover in an asphalt and bitumen transfer hose that is used to transfer high temperature petroleum-based materials such as tar, asphalt and hot oils having a temperature of about 200° F. to 400° F. These hoses generally are suitable for suction and discharge service on tank trucks, tank cars, or at bulk stations such as docks. As such, the ACM-based elastomeric composition forming the cover layer may have an original (as cured) tensile strength of at least 7 MPa according to ASTM D412 standard, and an original elongation at break of 200% minimum according to ASTM D412 standard. In exemplary embodiments, the ACM-based elastomeric composition may have a tensile strength of at least 10 MPa (e.g., in a range up to about 15 MPa) and an elongation at break of at least 300% (e.g., in a range up to about 500%) according to ASTM D412 standard. The ACM-based elastomeric composition also may have an abrasion resistance maximum of about 200 mm³ according to ASTM D5963 standard. In exemplary embodiments, the ACM-based elastomeric composition may have an abrasion resistance of less than about 170 mm³ (e.g., in a range as low as about 120 mm³). In certain embodiments, the ACM-based elastomeric composition has an original modulus at 100% in a range from about 2 MPa to about 5 MPa, such as about 3.5 MPa, and a Shore A hardness in a range from about 60 to about 75, such as about 67 according to ASTM D2240 standard.

The ACM-based elastomeric composition also may have suitable chemical and ozone resistant properties for use as the cover in an asphalt and bitumen transfer hose. As such, the ACM-based elastomeric composition forming the cover layer may have an ozone resistance of no cracking at 20% extension when tested after 168 hours at 50 pphm ozone at 40° C. according to ASTM D1149. The ACM-based elastomeric composition may have a resistance to bitumen of 50% maximum swell, 75% minimum retained tensile strength, 30% minimum retained elongation at break, and a +/−20 Hardness change according to ASTM D471 and ASTM D2240 standard when tested after 168 hours of immersion in PmB-bitumen 25 (55-55A) at 200° C. In exemplary embodiments, the ACM-based elastomeric composition has a resistance to bitumen according to ASTM D471 standard with a volume swell of less than 20%, or less than 10%, more particularly less than 5% (e.g., in a range as low as −5%); retained tensile strength of at least 85%, more particularly at least 90% (e.g., in a range as high as 110%); a retained elongation at break of at least 85%, more particularly at least 90% (e.g., in a range as high as 200%); and a Hardness point change of less than 10 points, more particularly 5 points or less (e.g., in a range as low as −10 point change).

### ECO Intermediate Layer

The intermediate layer 112 adjacent to the cover layer 106 is an epichlorohydrin elastomer (ECO) layer formed from an ECO-based elastomeric composition. The ECO-based elastomeric composition includes at least one ECO base polymer and one or more additives, each of which may be of any suitable type and provided in any suitable amount to form the intermediate layer 112, particularly with properties that are suitable for processing and co-curing with the ACM cover layer 106. The polymer matrix of the ECO-based elastomeric composition is formed from the ECO polymer(s), and optionally other polymer(s), to serve as the base of the composition. As such, the total polymer content forming the base composition (including mixtures of base polymers) is set at 100 phr. The additives are compounded relative to the total base polymer content of the composition, and as such may be represented in parts per hundred (phr). The elastomeric composition based on ECO (or the ECO-based elastomeric composition) means that a large majority (e.g., 75% or greater) of the polymer matrix is formed from one or more ECO polymers as opposed to other types of base polymers. In exemplary embodiments, the ECO polymer(s) constitute at least 90% by weight, more particularly at least 95%, at least 99%, or essentially 100% by weight (i.e., 100 phr) of the base polymer matrix of the ECO intermediate layer.

The ECO base polymer(s) of the intermediate layer 112 include at least epichlorohydrin (ECH) monomer. Generally, the ECO polymer is a copolymer or terpolymer of epichlorohydrin monomer and other monomer(s), of which one or more of these monomers provides an active cure site for vulcanization of the ECO-based elastomeric composition. Examples of such monomers other than ECH may include, for example, ethylene oxide (EO) and allyl glycidyl ether (AGE).

The ECO polymer(s) include chlorine cure sites which may be cured with the same or similar curative as is used for the ACM-based elastomeric composition (e.g., triazine). This promotes direct bonding of the ACM layer 106 and the ECO layer 112 together by co-vulcanization with the cure systems activating at least the chlorine cure-sites of both the ACM-based and ECO-based elastomeric compositions. Such chlorine cure sites of the ECO polymer(s) are present on at least the ECH monomer, for example, and provides for excellent heat and chemical resistance when cured.

In exemplary embodiments, the ECO polymer(s) also include sulfur cure sites in addition to the chlorine cure sites. This promotes direct bonding of the ECO layer 112 with a sulfur-curable adjacent material, such as intermediate layer 110, which as described below may be a nitrile butadiene elastomer (NBR) layer. In this manner, co-vulcanization of the ACM layer 106, the ECO layer 112, and the sulfur-curable (e.g., NBR) layer 110 with their respective cure systems forms direct bonding between each of these layers 106, 112, 110. Such sulfur cure sites of the ECO polymer(s) are present on at least the allyl glycidyl ether (AGE) monomer, for example. The ratio of the chlorine cure site monomer(s) (e.g., ECH) to the sulfur cure site monomer(s) (e.g., AGE) may be, for example (by weight of the polymer): about 60% to 70% ECO, about 10% to 20% AGE, and about 20% to 30% other monomer (e.g., EO, MAA, etc.). Suitable examples of ECO polymer(s) having a dual curable system with chlorine cure sites and sulfur cure sites include, for example, Hydrin H1100. Hydrin T3000, Hydrin T3000L, Hydrin T3000LL, Hydrin T3100, Hydrin T3102, Hydrin T3105, Hydrin T3106, Hydrin T3108, Hydrin T3108XL, Hydrin T5010, and Hydrin DP5120 by Zeon Chemicals.

The ECO-based elastomeric composition includes one or more reinforcing agents, which may include, for example, one or more carbon blacks, silicas, calcium carbonates (chalk), clays (kaolin), aluminum silicates, calcium silicates, magnesium silicates (talc), or other minerals, or mixtures thereof.

In exemplary embodiments, the ECO-based elastomeric composition contains one or more different types of the reinforcing agent(s) in a total amount from about 20 phr to about 100 phr, more particularly from about 40 phr to about 80 phr, more particularly from about 50 phr to about 70 phr, such as about 20, 30, 40, 50, 60, 70, 80, 90, or 100 phr. If too much total reinforcing agent is present, such as greater than the above-identified range(s), the elastomeric composition may become excessively stiff and less elastic, leading to a reduction in flexibility and elongation at break. If too little total reinforcing agent is added, such as below the above-identified range(s), the reinforcing effect may not be sufficient, leading to weaker mechanical properties of the composition.

In certain embodiments, the ECO-based elastomeric composition contains one or more carbon black(s) as a reinforcing agent. For example, the ECO-based elastomeric composition may contain carbon black(s) in a range between N300-series and N700-series. In some embodiments, the composition may include only one type of carbon black, such as N600-series (e.g., N₂ surface area of about 33-39 m²/g); for example, N650 carbon black, which may be present in the above-identified range(s).

The ECO-based elastomeric composition also may include one or more plasticizers, such as ethers, esters, adipates, or the like. In exemplary embodiments, the chosen plasticizer(s) of the ECO-based composition is/are a non-oil type, such as adipate plasticizer(s) (such as polyester adipate, etc.), ethers, esters, mixed ether/ester type plasticizer(s), or the like. As such, in exemplary embodiments, the ECO-based elastomeric composition is devoid of oil plasticizer.

The one or more plasticizers (e.g., adipate and/or ether/ester type) may be present in the ECO-based elastomeric composition in a total amount from about 1 phr to about 25 phr, more particularly from about 1 phr to about 10 phr, such as about 1, 2, 5, 10, 15, 20, or 25 phr. When two or more such plasticizer(s) are used, they may be present in the above-stated ranges or amounts in about equal proportions (e.g., about 1 to 10 phr polyester adipate plasticizer and about 1 to 10 phr of mixed ether/ester type plasticizer, in about equal amounts). In exemplary embodiments, the plasticizer system (including mixtures) may be the same system with the same or similar amounts as the ACM-based elastomeric composition so as to enhance compatibility and bondability between the ACM and ECO layers.

The ECO-based elastomeric composition also may include one or more processing aids, such as fatty acids (such as stearic acid), aliphatic fatty acid ester blends, amides, metal soaps of fatty acids, or the like. The one or more processing aid(s) (e.g., stearic acid and/or aliphatic fatty acid ester blend) may be present in the ECO-based elastomeric composition in a total amount from about 1 phr to about 10 phr, more particularly from about 1 phr to about 7 phr, such as about 1, 2, 5, 7 or 10 phr. When two or more such processing aid(s) are used, they may be present in the above-stated ranges or amounts in about equal proportions.

The ECO-based elastomeric composition also may include one or more antidegradants to protect the compound from degradation caused by exposure to oxygen and/or ozone. One example of a suitable antidegradant may include amine or benzimidazole antidegradants, such as octylated diphenylamine (ODP) or 2-mercaptotoluimidazole (MTI). The one or more antidegradant(s) (e.g., amine-type) may be present in the ECO-based elastomeric composition in a total amount from about 1 phr to about 5 phr, more particularly from about 1 phr to about 3 phr, such as about 1, 2, 3, 4 or 5 phr.

Because the ECO polymer(s) may have a relatively high amount of chlorine cure site monomer by virtue of the ECH monomer, the ECO-based elastomeric composition may further include one or more acid receptors. Examples of such acid receptors include, for example, calcium carbonate, magnesium oxide, calcium oxide, or the like. The one or more acid receptor(s) may be present in the ECO-based elastomeric composition in a total amount from about 1 phr to about 10 phr, more particularly from about 1 phr to about 7 phr, such as about 1, 2, 5, 7, or 10 phr. As an example, an acid receptor system with a mixture of acid receptors may include more calcium carbonate than magnesium oxide.

The ECO-based elastomeric composition also includes one or more suitable curatives, more particularly a cure system that can react with the chlorine cure sites of the ECO polymer(s) of the composition. In exemplary embodiments, the cure system includes a triazine compound, such as 2,4,6-trimercapto-1,3,5-triazine, for reacting with the chlorine cure sites to vulcanize the composition. The triazine cure system may be present in the ECO-based elastomeric composition in a total amount from about 0.2 to about 2 phr, such as about 1 phr. As noted above, the use of the same or similar cure system between the ECO-based composition and the ACM-based composition can enhance the adhesion between the ACM and ECO layers via co-vulcanization with the cure systems activating at least the chlorine cure-sites of both the ACM-based and ECO-based elastomeric compositions. Such vulcanization and bonding may be accomplished without the need for a post-cure.

The ECO-based elastomeric composition also may include one or more accelerators and/or one or more retarders to respectively accelerate or retard the cure of the composition. Examples of retarders may include phthalimide(s), such as N-(Cyclohexylthio) phthalimide or N-Phenyl-N-((trichloromethyl)thio)benzenesulfonamide. Such retarder(s) may be present in the ECO-based elastomeric composition in a total amount from about 0.5 to about 1 phr. Because the cure speed of ECO-based elastomeric composition is sufficient with only 2,4,6-trimercapto-1,3,5-triazine curative, the ECO-based elastomeric composition may be absent further accelerator(s).

In exemplary embodiments, the bonding performance between the ACM-based elastomeric composition of the ACM layer 106 and the ECO-based elastomeric composition of the ECO layer 112 exhibits a bond strength in terms of average load per width of at least 30 lbf/in., such as from about 30 lbf/in to about 200 lbf/inch, according to ASTM D413-98. In exemplary embodiments, the bond strength is greater than 50 lbf/in, or even greater than 60 lbf/in (e.g., up to about 100 lbf/inch], for example).

To enhance compatibility with the ACM cover layer 106 in the exemplary hose 100, the ECO-based elastomeric composition of the intermediate layer 112 should have suitable properties for use in hose, such as an asphalt and bitumen transfer hose. As such, the ECO-based elastomeric composition forming the intermediate layer 112 may have an original (as cured) tensile strength of at least 7 MPa, and an original elongation at break of 200% minimum according to ASTM D412. In exemplary embodiments, the ACM-based elastomeric composition may have a tensile strength of at least 10 MPa (e.g., in a range up to about 15 MPa) and an elongation at break of at least 300% (e.g., in a range up to about 500%) according to ASTM D412. The ECO-based elastomeric composition also may have an original modulus at 100% in a range from about 3 MPa to 7 MPa, such as about 5 MPa, and a Shore A hardness in a range from about 70 to 80, such as about 75.

### Reinforcement Layer

As shown in the illustrated embodiment of FIG. 1, the exemplary hose 100 includes reinforcement layer 104 between the ECO intermediate layer 112 and the inner tube 102. The reinforcement layer 104 provides additional strength to the hose, typically by applying strands of reinforcement. The strands may have any suitable configuration or combination of configurations, and the strands may be made of any suitable material or combination of materials for reinforcing the hose. The reinforcement layer 104 may include one or more layers of such strands, which these strand layers may be directly radially adjacent to each other and/or may be separated by intervening layer(s) of material (e.g., elastomeric layer between strand layers).

The reinforcement material of the strands may include, but is not limited to, metal, synthetic, natural material, or mixtures thereof. For example, the reinforcement strands may be metal wire (such as steel wire, stainless-steel wire, plated-steel wire, plain steel wire, or the like). Synthetic materials may include nylon, vinylon, aramid, rayon, polyester (such as polyethylene terephthalate or polyethylene naphthalate), polyvinyl acetate, polyvinyl alcohol (PVA), poly p-phenylene-2,6-benzobisoxazole (PBO), polypropylene, polyamide, carbon fiber, or the like. Natural, ceramic, mineral, etc. fibers may include cotton, jute, hemp, basalt, glass, or the like. To improve bonding of adjacent elastomeric material to the strands, the strands may be coated with a material, such as resorcinol formaldehyde resin or resorcinol formaldehyde latex (RFL), for example.

The reinforcement strands may include elongated fibers, filaments, threads, wires, or the like, or mixtures thereof, which may be in monofilament or multi-filament form. The individual strands may be grouped together to form bundles, tows, yarns, cords, or the like. Generally, a tow is a bundle of untwisted individual strands, a yarn is a bundle of twisted or cabled individual strands, and a cord is a twisted, braided, or cabled yarn or bundle of yarns. The individual strands or grouping of strands may be arranged in a spiral, braided, knitted, fabric, or wrapped reinforcement construction. In some embodiments, the hose may include one or more of these layers of reinforcement, and each layer may have a different orientation of strand arrangement. For example, where two or more layers of spiral reinforcement may be used, a first layer may be spiral wound in a first winding direction, and a second layer spiral wound in a second winding direction opposite the first winding direction. A braided configuration may include groupings of strands arranged in a 1-over, 1-under braid pattern, a 3-over, 3-under braid pattern, or a 4-over, 4-under braid pattern, or the like.

For the performance characteristics of an asphalt/bitumen transfer hose, the reinforcement layer 104 may be spiral wire helix between plies of polyester fabric.

### Other Intermediate Layer(s)

As shown in the illustrated embodiment, the exemplary hose 100 may include intermediate layers 108, 110 on opposite sides of the reinforcement. One or more of these intermediate layers 108, 110 may serve as bonding layers, such as tie or friction layers to effectively bond, or tie, the reinforcement to the inner and outer layer(s). For example, in exemplary embodiments, the outer intermediate layer 110 is directly bonded to the ECO layer 112 without an intervening adhesive layer, and the outer intermediate layer 110 is also bonded to the reinforcement strands of layer 104. In addition, the inner intermediate layer 108 may be directly bonded without intervening adhesive layer to the inner tube 102, and also may be bonded to the reinforcement strands of layer 104. In exemplary embodiments, the hose 100 is devoid of any intervening adhesive layers, which such direct bonding between layers can obviate problems associated with adhesives, such as the release of volatile organic compounds which can become trapped as bubbles between layers and/or which can be applied inconsistently, each of which can result in spotty adhesion between layers.

To promote direct bonding to the ECO intermediate layer 112, the inwardly adjacent intermediate layer 110 may be formed from an elastomeric composition that is based on a sulfur-curable elastomer and which includes a sulfur cure system. This is because, as noted above, the ECO polymer(s) of the ECO layer 112 include sulfur cure sites (in addition to the chlorine cure sites), which during co-vulcanization with the ECO layer 112, the sulfur cure system of the sulfur-curable elastomer layer 110 forms direct bonding between these layers 110, 112 via activation of the sulfur cure sites in each of these layers 110, 112.

In exemplary embodiments, the sulfur-curable elastomer that forms the base of the intermediate layer 110 is based on nitrile butyl rubber (NBR) (referred to herein as NBR intermediate layer). The NBR base polymer(s) of the intermediate layer 110 include at least acrylonitrile monomer and butadiene monomer, of which the allyl groups of the butadiene monomer provide an active sulfur cure site for vulcanization of the composition.

The NBR-based elastomeric composition of the intermediate layer 110 includes at least one NBR base polymer and one or more additives, each of which may be of any suitable type and provided in any suitable amount to form the intermediate layer 110, particularly with properties that are suitable for processing and co-curing with the ECO intermediate layer 112 and the ACM cover layer 106. The polymer matrix of the NBR-based elastomeric composition is formed from the NBR polymer(s), and optionally other polymer(s), to serve as the base of the composition. As such, the total polymer content forming the base of the composition (including mixtures of base polymers) is set at 100 phr. The additives are compounded relative to the total base polymer content of the composition, and as such may be represented in parts per hundred parts of rubber (phr). The elastomeric composition based on NBR (or the NBR-based elastomeric composition) means that a large majority (e.g., 75% or greater) of the polymer matrix is formed from one or more NBR polymers as opposed to other types of base polymers. In exemplary embodiments, the NBR polymer(s) constitute at least 90% by weight, more particularly at least 95%, at least 99%, or essentially 100% by weight (i.e., 100 phr) of the base polymer matrix of the NBR intermediate layer.

The NBR-based elastomeric composition includes one or more reinforcing agents, which may include, for example, one or more carbon blacks, silicas, calcium carbonates (chalk), clays (kaolin), aluminum silicates, calcium silicates, magnesium silicates (talc), or other minerals, or mixtures thereof.

In exemplary embodiments, the NBR-based elastomeric composition contains one or more different types of the reinforcing agent(s) in a total amount from about 20 phr to about 100 phr, more particularly from about 40 phr to about 80 phr, more particularly from about 50 phr to about 70 phr, such as about 20, 30, 40, 50, 60, 70, 80, 90, or 100 phr.

In certain embodiments, the NBR-based elastomeric composition contains an adhesion system, such as a mixture of phenol-formaldehyde resin, HMMM (hexamethylenetetramine), and silica. Such adhesion system provides good bonding between elastomer composition with reinforcement. One or more of the silica(s) may be of a precipitated form having a small size such as less than 100 nm. The overall silica content may be in a range from about 10 phr to about 60 phr (including all values and subranges therebetween). To improve bonding to the silica particles, a suitable silane may be used in the composition as well. The phenol-formaldehyde resin may be present in the NBR-based elastomeric composition in a total amount from about 5 to about 25 phr, more particularly from about 5 to 20 phr, such as 5, 10, 15, 20 or 25 phr. HMMM may be present in the NBR-based elastomeric composition in a total amount from about 0.1 to 2 phr, more particularly from about 0.1 to 1 phr, such as 0.1, 0.5, or 1 phr.

The NBR-based composition also may include clay as a reinforcing agent. The clay may be provided in any suitable amount, such as in a range from about 5 phr to about 20 phr, more particularly from about 5 phr to about 15 phr, such as 5, 10, 15 or 20 phr.

The NBR-based elastomeric composition also may include one or more plasticizers, such as ethers, esters, phthalates, aromatic oil, or the like. In exemplary embodiments, the chosen plasticizer(s) of the ECO-based composition is/are a non-oil type, such as a phthalate plasticizer(s) (e.g., diisononyl phthalate (DINP)), ethers, esters, or the like. The one or more plasticizers (e.g., phthalate) may be present in the NBR-based elastomeric composition in a total amount from about 1 phr to about 40 phr, such as about 1, 5, 10, 15, 20, 25, 30, 35 or 40 phr.

The NBR-based elastomeric composition also may include one or more processing aids, such as hydrocarbon resin, polyethylene glycol, aliphatic fatty acid ester blends, or the like. The one or more processing aid(s) (e.g., stearic acid) may be present in the NBR-based elastomeric composition in a total amount from about 1 phr to about 15 phr, more particularly from about 1 phr to about 10 phr, such as about 1, 2, 5, 7 or 10 phr.

The NBR-based elastomeric composition also may include one or more antidegradants. Examples of a suitable antidegradants may include amine, phosphite, or phenolic antidegradant, such as Wingstay L (butylated reaction product of p-cresol and dicyclopentadiene). The one or more antidegradant(s) may be present in the NBR-based elastomeric composition in a total amount from about 1 phr to about 5 phr, more particularly from about 1 phr to about 3 phr, such as about 1, 2, 3, 4 or 5 phr.

The NBR-based elastomeric composition also may include one or more activators, one or more accelerators and/or one or more retarders to respectively help activate, accelerate or retard the cure of the composition. Examples of suitable activator(s) may include zinc oxide and/or stearic acid, which may be present in the NBR-based composition in a total amount from about 1 phr to about 10 phr. Examples of accelerators may include thiazole(s), such as 2-mercaptobenzothiazole (MBTS) and/or disulfide(s), such as tetramethylthiuram disulfide (TMTD). Such accelerator(s) may be present in the NBR-based elastomeric composition in a total amount from about 1 phr to about 5 phr, for example.

The NBR-based elastomeric composition also includes one or more suitable curatives, more particularly a sulfur cure system that can react with the sulfur cure sites of the NBR polymer(s) of the composition. The cure system may be present in the NBR-based elastomeric composition in a total amount from about 1 phr to about 5 phr.

In exemplary embodiments, the bonding performance between the NBR-based elastomeric composition of the NBR layer 110 and the ECO-based elastomeric composition of the ECO layer 112 exhibits a bond strength in terms of average load per width of at least 30 lbf/in., such as from about 30 lbf/in to about 200 lbf/in, according to ASTM D413-98. In exemplary embodiments, the bond strength is greater than 50 lbf/in, or even greater than 100 lbf/in, or even greater than 150 lbf/in (e.g., up to about 200 lbf/in, for example).

The NBR-elastomeric layer also may have suitable bonding to the reinforcement strands of the reinforcement layer, such as via a coating material on the strands, such as resorcinol formaldehyde latex (RFL), for example.

The opposite intermediate layer 108 may be formed from the same or similar composition as the NBR-based intermediate layer 110. In particular, the inner intermediate layer 108 should have a suitable elastomeric composition (e.g., NBR-based elastomeric composition) that provides bonding to the reinforcement strands of layer 104 and the inner tube 102.

It is understood that although shown as separate and discrete layers, the elastomeric material of the intermediate layers 108, 110 may be calendered onto the reinforcement strands and thus these layers 108, 110 may be considered to also form a part of the reinforcement layer 104. Moreover, depending on the nature of the elastomeric material and construction of the reinforcement strands, such calendering may be done by applying to both sides of the reinforcement, or only one side of the reinforcement in which the material strikes through the voids between reinforcement strands. In either case, the calendered elastomeric material may strike through the voids to form a contiguous strand-reinforced layer that can be applied to the inner tube when forming the hose 100.

### Inner Tube Layer

In the exemplary hose 100 designed for asphalt/bitumen transfer, the inner tube 102 of the hose may be formed from any suitable material for transferring the product, such as a suitable elastomeric material, for example a sulfur-curable elastomer, such as an NBR-based elastomeric composition.

In exemplary embodiments, such an NBR-based elastomeric composition of the inner tube 102 may have a composition that promotes direct bonding to the outwardly adjacent intervening layer 108, which also may be an NBR-based elastomeric composition. These compositions may be the same or they may be different. Generally, since the inner tube NBR composition may have a high acrylonitrile (ACN) monomer content for resistance to asphalt/bitumen, the intermediate (e.g., friction) layer may have a different NBR composition, such as having at least a reduced ACN monomer content by weight as compared to the NBR inner tube layer.

### Method of Manufacture and Use

An exemplary method of forming the hose 100 may include at least the following steps: applying a first elastomeric composition for forming the inner tube 102; applying reinforcement around the first elastomeric composition for forming at least part of the reinforcement layer 104; applying a second elastomeric composition for forming an intermediate layer 112 around the reinforcement; applying a third elastomeric composition for forming the cover layer 106 around the second elastomeric composition; and co-curing the first, second, and third elastomeric compositions.

The third elastomeric composition of the cover layer 106 is the ACM-based elastomeric composition and the second elastomeric composition of the intermediate layer 112 is the ECO-based elastomeric composition as described above. The co-curing of these compositions (such as via autoclave steam curing) includes increasing the temperature to activate the cure system (e.g., triazine) and react with the chlorine cure sites in the compositions, whereby the ACM-based and ECO-based elastomeric compositions directly bond the layers 106 and 112 together.

As described above, the hose 100 may include additional intermediate layers 108, 110, and thus the method may include applying a fourth elastomeric composition after applying the reinforcement and before applying the second (intermediate) elastomeric composition and/or applying a fifth elastomeric composition after applying the first (inner tube) elastomeric composition and before applying the reinforcement. These composition(s) are also co-cured with the other layers.

The fourth elastomeric composition forming the intermediate layer 110 is a sulfur-curable elastomeric composition, such as the NBR-based elastomeric composition described above. During the co-curing, the cure system (e.g., sulfur) in the fourth (e.g., NBR-based) composition reacts with the sulfur cure sites in the fourth composition and can migrate to react with the sulfur cure sites in the ECO-based elastomeric composition, whereby the ECO-based and fourth (e.g., NBR-based) elastomeric compositions directly bond the layers 110 and 112 together. In addition, the cure system in the fourth (e.g., NBR-based) composition can react with cure sites of the coating material (e.g., RFL) of the reinforcement to cause direct bonding together of the layers 110 and 104.

The fifth elastomeric composition forming the intermediate layer 108 may be a sulfur-curable elastomeric composition, such as an NBR-based elastomeric composition described above. In addition, the first elastomeric composition forming the inner tube 102 may be a sulfur-curable elastomeric composition, such as an NBR-based elastomeric composition, as described above. During the co-curing, the cure systems (e.g., sulfur) in the first (e.g., NBR-based) and fifth (e.g., NBR-based) compositions react with the cure sites, whereby these elastomeric compositions directly bond the layers 102 and 108 together. In addition, the cure system in the fifth (e.g., NBR-based) composition can react with cure sites of the coating material (e.g., RFL) of the reinforcement to cause bonding of the layers 108 and 104.

The applying of the first, second, third, fourth and/or fifth elastomeric compositions may include providing the elastomeric composition(s) in a band of material and spiral wrapping the band over the previous spiral-wrapped layer.

The applying the reinforcement may include providing the reinforcement as a calendered layer including the fourth and/or fifth elastomeric compositions on side(s) of the reinforcement. Such applying may include providing the calendered layer as a band which is spiral wrapped over the previous spiral-wrapped layer.

In the context of an asphalt and bitumen transfer hose, such hose 100 may have suitable coupling on either end and be used in a system having a source of asphalt/bitumen, in which the method of use includes transferring the asphalt/bitumen from the source via the hose.

### Compositional Alternatives

Although exemplary polymer(s) and additive(s) of the elastomeric compositions (ACM-based, ECO-based, NBR-based, etc.) have been described above, it is understood that these composition could eliminate some additive(s), include different additive(s) or additional additives(s), or additional polymer(s), each of which may be of any suitable type and in any suitable amount to form the desired article.

### Article Alternatives

FIG. 2 shows a cross-sectional view of an article 200 having an ACM elastomeric layer 206 formed from the ACM-based elastomeric composition described above (cf. layer 106), which is directly bonded to an ECO elastomeric layer 212 formed from the ECO-based elastomeric layer described above (cf. 112). The article 200 may form at least part of a hose, a belt, a strap, a seal, a conveyor belt, a power transmission belt, an air spring bellows, a damper, a compensator, or the like. The ACM-layer 206 may be the outermost, abrasion-resistant layer of such article 200.

FIG. 3 shows a cross-sectional view of another article 300 that is similar to article 200, except that article 300 further includes a layer 310 formed from a sulfur-curable elastomeric composition, such as the NBR-based elastomeric composition described above, which is directly bonded to the ECO layer 312 (which is the same as ECO layer 212), and which this layer is directly bonded to the ACM layer 306 (which is the same as ACM layer 206).

Although only two or three layers are shown in articles 200 and 300, it is understood that such article could include additional layers. For example, an additional reinforcement layer may be provided in articles 200, 300; or the layer 310 could be a reinforcement layer, for example. The reinforcement layer may be the same as or similar to reinforcement layer 104 described above. Alternatively, the reinforcement layer may include a different configuration of reinforcement strands than are used with a hose. The reinforcement strands in the layer may include bi-directional, non-woven, woven, knitted, or braided fabric. The fabric may include warp and weft threads laid at any desired angle. The fabric layer may be a plated knitted fabric including courses of yarn knitted together. In some embodiments, more than one ply of fabric may be employed. If desired, the fabric may be cut on a bias so that the strands form an angle with the longitudinal direction of the. The angle may be of any suitable angle, for example, but not limited to 0 or 90 degrees, or any point along the continuum there between. The fabrics for use in reinforcement layer may be formed from any suitable material or combination of materials. For example, the fabrics for use in the reinforcement layer may be formed from materials including nylon (such as nylon 4,6, nylon 6, 6, and nylon 6), cotton, polyester, cotton/polyester, nylon/polyester, cotton/nylon, aramid, rayon, or the like. Hybrid designs, for reinforcement layer may be coated with an elastomeric material. In some embodiments, the fabric layer may have a different coating on one side to assure that the fabric layer is bonded to the elastomeric layer (for example); and may have a different coating on the opposite side to provide low friction, abrasion resistance, or other suitable function.

### EXAMPLES

Exemplary elastomeric compositions were prepared and tested for the purpose of further illustrating the nature of some of the embodiments and aspects of the disclosure and are not intended as a limitation on the scope thereof. These examples according to the disclosure, along with comparative examples, are shown in Tables 1-6. In the examples, the rheometer testing was performed according to ASTM D5289; the tensile and elongation testing was performed according to ASTM D412; the hardness testing was performed according to ASTM D2240; the ozone testing was performed according to ASTM D1149; the PmB-bitumen immersion testing was performed according to the DIN abrasion testing was performed according to ASTM D471 standard; and the IRM903 immersion testing was performed according to ASTM D471 standard.

Table 1 illustrates an exemplary ACM-based elastomeric composition according to the disclosure (“Ex. 1”).

TABLE 1

| | Ex. 1 |
|---|---|
| Ingredient | |
| Base Elastomer: ACM Polymer | 100 |
| Reinforcing Agent: Carbon black | 65 |
| Plasticizer: Polyester adipate | 2.5 |
| Plasticizer: Ether/ester mix | 2.5 |
| Process Aid: Stearic acid | 2 |
| Process Aid: Fatty acid ester | 3 |
| Antidegradant: Amine-type | 2 |
| Curative: Triazine | 0.5 |
| Accelerator: Dithiocarbamate | 2 |
| Retarder: Sulfonomide | 0.5 |
| Total phr | 180 |
| Rheometer (60 mins/165° C.) | |
| Min | 4.23 |
| Max | 15.3 |
| Tris1 | 5.16 |
| T25 | 8.52 |
| S25 | 7 |
| T90 | 29.35 |
| S90 | 14.2 |
| Rate | 0.77 |
| Amount | 11.07 |
| Original Physical Properties | |
| Tensile, MPa | 10.6 |
| Elongation, % | 345 |
| Mod 100, MPa | 3.5 |
| Shore A Hardness | 67 |
| Static Ozone | |
| (168 hrs/50 pphm/40° C./20% strain) | no |
| | cracking |
| PmB-bitumen 25(55-55A) | |
| Immersion (168 hrs/200° C.) | |
| Tensile, MPa | 10.7 |
| Elongation, % | 533 |
| Mod 100, MPa | 1.7 |
| Shore A Hardness | 62 |
| Vol Swell, % | −1 |
| Tensile retention, % | 101 |
| Elongation retention, % | 154 |
| Hardness change, pts | −5 |
| DIN Abrasion, mm³ | 163 |
| IRM903 Immersion (168 hrs/200° C.) | |
| Tensile, MPa | 9.6 |
| Elongation, % | 564 |
| Mod 100, MPa | 1.1 |
| Shore A Hardness | 45 |
| Vol Swell % | 15 |
| Tensile retention, % | 91 |
| Elongation retention, % | 163 |
| Hardness change, pts | −22 |

As shown in the results, the ACM-based elastomeric composition of Example 1 exhibits an original tensile strength of 10.6 Mpa and an original elongation at break of 345%. The ACM-based composition also exhibits a tensile retention (from original to post-PmB-bitumen immersion) of 101%, an elongation retention of 154%, and a hardness change of −5 points Shore A. The ACM-based composition also exhibits a volume swell (from original to post-PmB-bitumen immersion) of −1%. The ACM-based composition also has an ozone resistance of no cracking at 20% extension, and also has an abrasion resistance of 163 mm³. Accordingly, the ACM-based elastomeric composition satisfies the specifications of the DIN EN 13482:2013 standard for a cover layer 106 of an asphalt and bitumen transfer hose.

Table 2 illustrates an exemplary ECO-based elastomeric composition according to the disclosure (“Ex. 2”).

TABLE 2

| | Ex. 2 |
|---|---|
| Ingredient | |
| Base Elastomer: ECO polymer | 100 |
| Reinforcing Agent: Carbon black | 65 |
| Plasticizer: Polyester adipate | 2.5 |
| Plasticizer: Ether/ester mix | 2.5 |
| Process Aid: Stearic acid | 2 |
| Process Aid: Fatty acid ester | 3 |
| Antidegradant: Amine-type | 2 |
| Acid Receptor: Calcium carbonate | 5 |
| Acid Receptor: Magnesium oxide | 1 |
| Curative: Triazine | 1 |
| Retarder: Phthalimide | 0.5 |
| Total phr | 184.5 |
| Rheometer (60 mins/165° C.) | |
| Min | 4.8 |
| Max | 33.7 |
| Tris1 | 1.95 |
| T25 | 5.89 |
| S25 | 12.02 |
| T90 | 46.67 |
| S90 | 30.81 |
| Rate | 2.75 |
| Amount | 28.9 |
| Original Physical Properties | |
| Tensile, MPa | 11.6 |
| Elongation, % | 336 |
| Mod 100, MPa | 5.1 |
| Shore A Hardness | 75 |

In Example 2, the plasticizers, processing aids, and antidegradants are the same respective types as in Example 1. The triazine curative in Examples 1 and 2 also is the same.

As shown in the results, the ECO-based elastomeric composition of Example 2 exhibits an original tensile strength of 11.6 Mpa, an original elongation at break of 336%, and a Shore A hardness of 75. As such, the ECO-based elastomeric composition has properties that make is suitable as a layer of a hose, such as intermediate layer 110.

Table 3 illustrates an exemplary NBR-based elastomeric composition according to the disclosure (“Ex. 3”).

TABLE 3

| | Ex. 3 |
|---|---|
| Ingredient | |
| Base Elastomer: NBR polymers | 100 |
| Reinforcing Agent: Clay | 10.08 |
| Plasticizer: Phthalate | 24 |
| Activator: Zinc Oxide | 4 |
| Activator: Stearic acid | 1.5 |
| Processing aid: Hydrocarbon resin | 5 |
| Processing aid: Polyethylene Glycol | 1.25 |
| Adhesion system: Silica | 44 |
| Adhesion system: Hexamethylenetetramine | 0.5 |
| Adhesion system: phenol-formaldehyde resin | 10 |
| Antidegradant: Polyphenolic | 1 |
| Rubber Curative: Sulfur | 2.55 |
| Accelerator: Thiazole | 1.45 |
| Accelerator: Thiuram disulfide | 0.3 |
| Pigment | 7.5 |
| Total phr | 213.13 |
| Rheometer (30 mins/165° C.) | |
| Min | 2.25 |
| Max | 24.47 |
| Tris1 | 0.44 |
| T25 | 1.39 |
| S25 | 7.66 |
| T90 | 2.44 |
| S90 | 22.23 |
| Rate | 31.19 |
| Amount | 22.22 |
| Original Physical Properties | |
| Tensile, MPa | 16.1 |
| Elongation, % | 695 |
| Mod 100, Mpa | 1.2 |
| Shore A Hardness | 57 |

As shown in the results, the NBR-based elastomeric composition of Example 3 exhibits an original tensile strength of 16.1 MPa, an original elongation at break of 695%, and a Shore A hardness of 57. As such, the NBR-based elastomeric composition has properties that make is suitable as a layer of a hose, such as intermediate layer 110.

Table 4 illustrates a comparative NBR-based elastomeric composition (“Comp. 1”) that utilizes a peroxide curative system instead of a sulfur cure system as is the case with the NBR-based composition of Example 3.

TABLE 4

| Ingredients | Comp. 1 |
|---|---|
| NBR | 100 |
| Carbon black | 95 |
| Silica | 15 |
| Ester plasticizer | 14 |
| Dialkylether glutarate plasticizer | 14 |
| Quinoline antidegradant | 2 |
| Silane coupling agent (50%) | 2 |
| Diphenylamine antidegradant | 2 |
| Zinc Oxide | 5 |
| Dimaleimide peroxide cure agent | 1.5 |
| Peroxide (40%) | 4.6 |
| Zeonet PB (72%) | 4.2 |
| Total phr | 259.3 |

Table 5 illustrates a comparative chlorinated polyethylene (CPE)-based elastomeric composition (“Comp. 2”) that utilizes a triazine cure system that is the same as the triazine cure systems of Examples 1 and 2.

TABLE 5

| Ingredients | Comp. 2 |
|---|---|
| CPE | 100 |
| Carbon black | 50 |
| Calcium carbonate | 20 |
| Silica | 20 |
| Phthalate plasticizer | 35 |
| Aromatic oil | 20 |
| MgO | 5 |
| Zisnet F-ET | 2 |
| Quinoline antidegradant | 0.25 |
| Tetrabutylammonium Bromide (50%) | 2 |
| Phenolic antidegradant | 0.5 |
| Total phr | 254.75 |

Table 6 illustrates a comparison of the bonding performance between the various compositions of Examples 1-3 and Comparative Examples 1 and 2. The bond testing was performed according to ASTM D413-98 peel test in which the composite test sample including the elastomeric compositions were co-cured under pressure of 80 psi. No intervening adhesive layers were used in any of the tests. The results are characterized by an average load per width and have a unit of lbf/inch.

In Table 6, Example A depicts the results of bond testing between the NBR-based elastomeric composition of Example 3 and the ECO-based elastomeric composition of Example 2. Example A also depicts the results of bond testing between the ECO-based elastomeric composition of Example 2 and the ACM-based elastomeric composition of Example 1. As such, Example A depicts the bonding performance expected of an exemplary composite structure that has at least the ACM layer, the ECO layer, and the NBR layer, such as for the hose 100 described above. As shown in the results of Example A, such a three-part composite structure exhibits excellent bonding performance with a bond strength of 177 lbf/inch between the NBR-based composition (Ex. 3) and the ECO-based composition (Ex. 2); and exhibits good bonding performance with a bond strength of 65 lbf/inch between the ECO-based composition (Ex. 2) and the ACM-based composition (Ex. 1). The use of the same types of plasticizers and/or curative between the ECO-based composition (Ex. 2) and the ACM-based composition (Ex. 1) also is believed to help enhance this bonding performance. In view of these results, such a composite structure having the NBR layer on one side of the ECO layer and the ACM layer on the opposite side of the ECO layer can provide suitable bonding performance for use in a hose, such as an asphalt and bitumen transfer hose.

TABLE 6

Adhesion Between Layers (lbf/inch)

| Ex. A | Ex. 3 NBR/ | Ex. 2 ECO/ |
|---|---|---|
| (NBR/ECO/ACM) | Ex. 2 ECO | Ex. 1 ACM |
| | 177 | 65 |
| Comp. A | Ex. 3 NBR/ | |
| (NBR/ACM) | Ex. 1 ACM | |
| | 11 | |
| Comp. B (NBR/ | Ex. 3 NBR/ | Comp. 1 NBR/ |
| Peroxide NBR/ACM) | Comp. 1 NBR | Ex. 1 ACM |
| | 114 | 10 |
| Comp. C (NBR/ | Ex. 3 NBR/ | Comp. 2 CPE/ |
| Triazine CPE/ACM) | Comp. 2 CPE | Ex. 1 ACM |
| | 86 | 4 |

Comparative Example A in Table 6 depicts the results of bond testing between the NBR-based elastomeric composition of Example 3 and the ACM-based elastomeric composition of Example 2. As shown in the results, such an NBR-based composition exhibits low bond strength of 11 lbf/in. to the ACM-based composition, thus highlighting the improvement obtained by utilizing the ECO-based composition of Example 2 as an intermediate bonding layer.

Comparative Example B in Table 6 depicts the results of bond testing between the NBR-based elastomeric composition of Example 3 and the peroxide cured NBR-based elastomeric composition of Comparative Example 1. Comparative Example B also depicts the results of bond testing between the peroxide cured NBR composition (Comp. 1) and the ACM-based elastomeric composition of Example 1. As shown in the results, the peroxide cured NBR composition (Comp. 1) also exhibits low bond strength of 10 lbf/in. to the ACM-based composition (Ex. 1), similarly to the poor results from Comparative Example A. This again highlights the improvement obtained by utilizing the ECO-based composition of Example 2 as an intermediate bonding layer.

Comparative Example C in Table 6 depicts the results of bond testing between the NBR-based elastomeric composition of Example 3 and the triazine cured CPE-based elastomeric composition of Comparative Example 2. Comparative Example C also depicts the results of bond testing between the triazine cured CPE composition (Comp. 2) and the ACM-based elastomeric composition of Example 1. As shown in the results, the triazine cured CPE composition (Comp. 2) also exhibits low bond strength of 4 lbf/in. to the ACM-based composition (Ex. 1). This again highlights the improvement obtained by utilizing the ECO-based composition of Example 2 as an intermediate bonding layer.

Article(s) such as multilayer hose(s) have been described herein. The article(s) such as the hose(s) include a polyacrylic elastomer (ACM) layer directly bonded to an epichlorohydrin elastomer (ECO) layer without an intervening adhesive layer. The ACM layer is formed from an ACM-based elastomeric composition including at least one polymer having one or more acrylate monomer(s), in which the at least one polymer includes chlorine cure-sites; and a triazine cure system that vulcanizes the ACM-based composition via at least the chlorine cure-sites. The ECO layer is formed from an ECO-based elastomeric composition including at least one polymer having epichlorohydrin monomer, in which the at least one polymer includes chlorine cure-sites; and a triazine cure system that vulcanizes the ECO-based composition via at least the chlorine cure-sites. The ACM layer and the ECO layer are directly bonded together by co-vulcanization with the triazine cure systems activating at least the chlorine cure-sites of the ACM-based and ECO-based elastomeric compositions.

According to an aspect, a multilayer hose includes: a polyacrylic elastomer (ACM) layer directly bonded to an epichlorohydrin elastomer (ECO) layer without an intervening adhesive layer, the ACM elastomer layer being formed from an ACM-based elastomeric composition including: at least one polymer having one or more acrylate monomer(s), in which the at least one polymer includes chlorine cure-sites; and a triazine cure system that vulcanizes the ACM-based elastomeric composition via at least the chlorine cure-sites; the ECO elastomeric layer being formed from an ECO-based elastomeric composition including: at least one polymer having epichlorohydrin monomer, in which the at least one polymer includes chlorine cure-sites; and a triazine cure system that vulcanizes the ECO-based elastomeric composition via at least the chlorine cure-sites; wherein the ACM layer and the ECO layer are directly bonded together by co-vulcanization with the triazine cure systems activating at least the chlorine cure-sites of the ACM-based and ECO-based elastomeric compositions.

Exemplary embodiment(s) may include one or more of the following additional features combined with any of the foregoing or following aspects, in which one or more of these additional features may be combined separately or in any suitable combination with each other.

In exemplary embodiment(s), the hose further including: a nitrile butadiene elastomer (NBR) layer directly bonded to the ECO layer, the NBR layer being formed from an NBR-based elastomeric composition including: one or more polymer(s) having acrylonitrile monomer and butadiene monomer; and a sulfur cure system; wherein the at least one polymer of the ECO-based elastomeric composition of the ECO layer includes sulfur cure sites in addition to the chlorine cure sites, such that co-vulcanization of the ECO layer, the NBR layer, and the ACM layer with their respective cure systems forms a direct bond between each layer.

In exemplary embodiment(s), the ACM layer and the ECO layer exhibit a bond strength of 30 lbf/in or greater, more particularly 50 lbf/in or greater and up to 200 lbf/in, according to ASTM D413-98.

In exemplary embodiment(s), the ECO layer and the NBR layer exhibit a bond strength of 30 lbf/in or greater, more particularly 50 lbf/in or greater, more particularly 150 lbf/in or greater and up to 200 lbf/in, according to ASTM D413-98.

In exemplary embodiment(s), the ACM layer retains at least 75% of its original tensile strength when tested according to ASTM D412 after being immersed in PmB-bitumen 25 (55-55a) for 168 hours at 200° C. according to ASTM D471; more particularly, the ACM layer retains at least 85% of its original tensile strength, more particularly at least 90% of its original tensile strength when tensile tested after being immersed in PmB-bitumen 25 (55-55a) for 168 hours at 200° C. according to ASTM D471.

In exemplary embodiment(s), the ACM layer retains at least 30% of its original elongation at break when tested according to ASTM D412 after being immersed in PmB-bitumen 25 (55-55a) for 168 hours at 200° C. according to ASTM D471; more particularly the ACM layer retains at least 85% of its original elongation at break, more particularly at least 90% of its original elongation at break when tested according to ASTM D412 after being immersed in PmB-bitumen 25 (55-55a) for 168 hours at 200° C. according to ASTM D471.

In exemplary embodiment(s), the ACM layer exhibits a volume change of no greater than 50% after being immersed in PmB-bitumen 25 (55-55a) for 168 hours at 200° C. according to ASTM D471; more particularly the ACM layer exhibits a volume change of no greater than 15%, more particularly no greater than 5% after being immersed in PmB-bitumen 25 (55-55a) for 168 hours at 200° C. according to ASTM D471.

In exemplary embodiment(s), the ACM layer exhibits a hardness change of no greater than 20 points when tested according to ASTM D2240 after being immersed in PmB-bitumen 25 (55-55a) for 168 hours at 200° C. according to ASTM D471; more particularly the ACM layer exhibits a hardness change of no greater than 10 points, more particularly no greater than 5 points when tested according to ASTM D2240 after being immersed in PmB-bitumen 25 (55-55a) for 168 hours at 200° C. according to ASTM D471.

In exemplary embodiment(s), the ACM layer exhibits an original tensile strength of at least 7 MPa when tested according to ASTM D412, more particularly at least 10 MPa, more particularly up to 15 MPa.

In exemplary embodiment(s), the ACM layer exhibits an original elongation at break of at least 200% when tested according to ASTM D412, more particularly at least 300%, more particularly up to 500%.

In exemplary embodiment(s), the ACM layer exhibits an abrasion value of less than 200 mm³-when tested according to ASTM D5963, more particularly less than 170 mm³.

In exemplary embodiment(s), the ACM layer exhibits an ozone resistance of no cracking at 20% extension when tested after 168 hours at 50 pphm ozone at 40° C. according to ASTM D1149.

In exemplary embodiment(s), the ACM-based elastomeric composition and the ECO-based elastomeric composition have the same type of plasticizer(s) and/or triazine cure system to promote compatibility and the direct bonding between layers.

In exemplary embodiment(s), the at least one polymer of the ECO-based elastomeric composition further includes allyl glycidyl ether (AGE) monomer in addition to the epichlorohydrin (ECH) monomer, the chlorine cure sites being present on the ECH monomers of the at least one polymer, and the sulfur cure sites being present on the AGE monomers of the at least one polymer.

In exemplary embodiment(s), further including a reinforcement layer that includes reinforcement strands; wherein the ACM layer is an outer cover layer, the ECO layer is an intermediate layer inwardly of the ACM layer, and the NBR layer is an intermediate layer disposed inwardly of the ECO layer and outwardly of the reinforcement layer.

In exemplary embodiment(s), the NBR layer is bonded to the reinforcement strands of the reinforcement layer, more particularly via a coating on the reinforcement strands.

In exemplary embodiment(s), the NBR layer is a first NBR layer, the hose further including a second nitrile butadiene elastomer (NBR) layer bonded to the reinforcement strands on an opposite side of the reinforcement layer.

In exemplary embodiment(s), the hose further including an inner tube layer defining a lumen of the hose, wherein the inner tube layer is directly bonded to the second NBR layer without an intervening adhesive layer.

In exemplary embodiment(s), the inner tube layer is formed from a nitrile butadiene elastomer (NBR); more particularly wherein the NBR of the inner tube layer is a different composition from the second NBR layer; more particularly wherein the first and second NBR layers have the same composition.

In exemplary embodiment(s), the ACM cover layer, the ECO intermediate layer, the first NBR intermediate layer, the second NBR intermediate layer, and the NBR inner tube layer are co-cured together to form the direct bonding between layers and to form the hose without a post-cure.

In exemplary embodiment(s), the triazine cure system of the ACM-based elastomeric composition and/or the triazine cure system of the ECO-based elastomeric composition is 2,4,6-trimercapto-1,3,5-triazine.

According to an aspect, an asphalt and/or bitumen transfer system includes: a source of asphalt and/or bitumen; and the hose according to any of the foregoing fluidly coupled to the source and configured to transfer the asphalt and/or bitumen.

According to an aspect, a method of using an asphalt and/or bitumen transfer hose, includes: providing the hose according to any of the foregoing; and conveying asphalt and/or bitumen with the hose.

According to an aspect, a method of manufacturing the multilayer hose according to any of the foregoing includes: applying the ECO-based elastomeric composition to form the ECO layer of the hose; and applying the ACM-based elastomeric composition to form the ACM layer of the hose; wherein the ECO layer and the ACM layer are in direct contact without an intervening adhesive layer therebetween; and co-vulcanizing the ACM layer and the ECO layer, wherein the co-vulcanizing activates at least the chlorine cure sites with the triazine cure systems and directly bonds the ACM and ECO layers together.

According to an aspect, a multilayer hose includes: an inner tube layer, a reinforcement layer including reinforcement strands disposed outwardly of the inner tube layer, a nitrile butadiene elastomer (NBR) layer bonded to the reinforcement strands, the NBR layer being formed from an NBR-based elastomeric composition including (i) one or more polymer(s) having acrylonitrile monomer and butadiene monomer; and (ii) a sulfur cure system; an epichlorohydrin elastomer (ECO) layer directly bonded to the NBR layer without an intervening adhesive layer, the ECO elastomeric layer being formed from an ECO-based elastomeric composition including: (i) at least one polymer including epichlorohydrin monomer, in which the at least one polymer includes chlorine cure-sites and sulfur cure sites; and (ii) a triazine cure system that vulcanizes the ECO-based elastomeric composition via at least the chlorine cure-sites; and a polyacrylic elastomer (ACM) layer directly bonded to the ECO layer without an intervening adhesive layer, the ACM elastomer layer being formed from an ACM-based elastomeric composition including: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites; wherein co-vulcanization of the respective elastomeric compositions of the NBR layer, the ECO layer, and the ACM layer with their respective cure systems forms direct bonding between the NBR, ECO and ACM layers.

Exemplary embodiment(s) may include one or more of the following additional features combined with any of the foregoing or following aspects, in which one or more of these additional features may be combined separately or in any suitable combination with each other.

In exemplary embodiment(s), the ACM layer and the ECO layer exhibit a bond strength in a range from 30 lbf/in to 200 lbf/in when tested according to ASTM D413-98.

In exemplary embodiment(s), the ECO layer and the NBR layer exhibit a bond strength from 30 lbf/in to 200 lbf/in when tested according to ASTM D413-98.

In exemplary embodiment(s), the ACM layer retains at least 75% of its original tensile strength when tested according to ASTM D412 after being immersed in PmB-bitumen 25 (55-55a) for 168 hours at 200° C. according to ASTM D471.

According to an aspect, a method of manufacturing a multilayer hose, includes: applying a first elastomeric composition for forming an inner tube of the hose; applying reinforcement including reinforcement strands around the first elastomeric composition for forming at least part of a reinforcement layer; applying a second elastomeric composition for forming an intermediate layer around the reinforcement, wherein the second elastomeric composition is an epichlorohydrin elastomer (ECO) based elastomeric composition including: (i) at least one polymer including epichlorohydrin monomer, in which the at least one polymer includes chlorine cure-sites; and (ii) a triazine cure system that vulcanizes the ECO-based elastomeric composition via at least the chlorine cure-sites; applying a third elastomeric composition for forming a cover layer around the intermediate layer, wherein the third elastomeric composition is a polyacrylic elastomer (ACM) based elastomeric composition including: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites; and co-vulcanizing the first, second, and third elastomeric compositions, wherein the co-vulcanizing activates at least the chlorine cure sites with the triazine cure systems of the ACM-based and ECO-based elastomeric compositions and directly bonds the intermediate layer and the cover layer together.

Exemplary embodiment(s) may include one or more of the following additional features combined with any of the foregoing or following aspects, in which one or more of these additional features may be combined separately or in any suitable combination with each other.

In exemplary embodiment(s), the method further including applying a fourth elastomeric composition after applying the reinforcement and before applying the second elastomeric composition for forming a second intermediate layer, the fourth elastomeric composition being a nitrile butadiene elastomer (NBR) based elastomeric composition including: one or more polymer(s) having acrylonitrile monomer and butadiene monomer; and a sulfur cure system; wherein the at least one polymer of the ECO-based elastomeric composition includes sulfur cure sites in addition to the chlorine cure sites; and wherein the co-vulcanizing includes co-vulcanizing the fourth elastomeric composition, and wherein the co-vulcanizing activates at least the sulfur cure sites of the ECO-based elastomeric composition with the sulfur cure system of the NBR-based elastomeric composition and directly bonds the intermediate layer and the second intermediate layer together.

In exemplary embodiment(s), the co-vulcanizing activates at least sulfur cure sites of a material of the reinforcement strands and bonds the NBR-based elastomeric composition to the material of the reinforcement strands.

In exemplary embodiment(s), the method further including applying a fifth elastomeric composition after applying the first elastomeric composition and before applying the reinforcement for forming a third intermediate layer, the fifth elastomeric composition being a nitrile butadiene elastomer (NBR) based elastomeric composition; wherein the first elastomeric composition for forming the inner tube is an NBR-based elastomeric composition; and wherein the co-vulcanizing includes co-vulcanizing the fifth elastomeric composition, and wherein the co-vulcanizing directly bonds the NBR-based elastomeric composition of the third intermediate layer to the NBR-based elastomeric composition of the inner tube layer.

In exemplary embodiment(s), the co-vulcanizing bonds the NBR-based elastomeric composition of the third intermediate layer to the material of the reinforcement strands.

In exemplary embodiment(s), the applying of the first, second, third, fourth and/or fifth elastomeric compositions includes providing the respective elastomeric composition(s) in a band of material and spiral wrapping the band over the previous spiral-wrapped layer.

In exemplary embodiment(s), the applying the reinforcement includes providing the reinforcement as a calendered layer including the fourth and/or fifth elastomeric compositions on side(s) of the reinforcement, the applying includes providing the calendered layer as a band which is spiral wrapped over the previous spiral-wrapped layer.

According to an aspect, an article includes: a polyacrylic elastomer (ACM) layer directly bonded to an epichlorohydrin elastomer (ECO) layer without an intervening adhesive layer, the ACM elastomer layer being formed from an ACM-based elastomeric composition including: at least one polymer having one or more acrylate monomer(s), in which the at least one polymer includes chlorine cure-sites; and a triazine cure system that vulcanizes the ACM-based elastomeric composition via at least the chlorine cure-sites; the ECO elastomeric layer being formed from an ECO-based elastomeric composition including: at least one polymer having epichlorohydrin monomer, in which the at least one polymer includes chlorine cure-sites; and a triazine cure system that vulcanizes the ECO-based elastomeric composition via at least the chlorine cure-sites; wherein the ACM layer and the ECO layer are directly bonded together by co-vulcanization with the triazine cure systems activating at least the chlorine cure-sites of the ACM-based and ECO-based elastomeric compositions.

In exemplary embodiment(s), the article is constructed as a hose, a belt, a strap, a seal, a conveyor belt, a power transmission belt, an air spring bellows, or a damper.

In exemplary embodiment(s), the ACM layer forms an outer layer of the article.

In exemplary embodiment(s), the article includes one or more of any of the foregoing features of any other aspect, separately or in any suitable combination.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

It is to be understood that terms such as “top,” “bottom,” “upper,” “lower,” “left,” “right,” “front,” “rear,” “forward,” “rearward,” or the like may refer to an arbitrary frame of reference, rather than to the ordinary gravitational frame of reference.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) had possession of the entire range and all points within the range.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or +0.0% of the stated value, as well as values intervening such stated values. When the term “about” is used in describing a value or an end-point of a range, the disclosure should be understood to include the specific value or end-point referred to.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

### LIST OF REFERENCE NUMERALS (PART OF THE DESCRIPTION

100 Hose
102 Inner tube layer
104 Reinforcement Layer
106 ACM Cover Layer
108 Intermediate Layer
110 Intermediate (Nitrile) Layer
112 ECO Intermediate Layer
200, 300 Article
206, 306 ACM Layer
212, 312 ECO Layer
310 Layer (Nitrile or Reinforcement)

1. A multilayer hose comprising:
a polyacrylic elastomer (ACM) layer directly bonded to an epichlorohydrin elastomer (ECO) layer without an intervening adhesive layer,
the ACM elastomer layer being formed from an ACM-based elastomeric composition comprising:
at least one polymer having one or more acrylate monomer(s), in which the at least one polymer includes chlorine cure-sites; and
a triazine cure system that vulcanizes the ACM-based elastomeric composition via at least the chlorine cure-sites;
the ECO elastomeric layer being formed from an ECO-based elastomeric composition comprising:
at least one polymer having epichlorohydrin monomer, in which the at least one polymer includes chlorine cure-sites; and
a triazine cure system that vulcanizes the ECO-based elastomeric composition via at least the chlorine cure-sites;
wherein the ACM layer and the ECO layer are directly bonded together by co-vulcanization with the triazine cure systems activating at least the chlorine cure-sites of the ACM-based and ECO-based elastomeric compositions.

2. The hose according to claim 1, further comprising:
a nitrile butadiene elastomer (NBR) layer directly bonded to the ECO layer, the NBR layer being formed from an NBR-based elastomeric composition comprising:
one or more polymer(s) having acrylonitrile monomer and butadiene monomer; and
a sulfur cure system;
wherein the at least one polymer of the ECO-based elastomeric composition of the ECO layer includes sulfur cure sites in addition to the chlorine cure sites, such that co-vulcanization of the ECO layer, the NBR layer, and the ACM layer with their respective cure systems forms a direct bond between each layer.

3. The hose according to claim 1, wherein:
the ACM layer and the ECO layer exhibit a bond strength between each other from 30 lbf/in to 200 lbf/in, according to ASTM D413-98.

4. The hose according to claim 2, wherein:
the ECO layer and the NBR layer exhibit a bond strength between each other from 30 lbf/in to 200 lbf/in, according to ASTM D413-98.

5. The hose according to claim 1, wherein:
the ACM layer retains at least 75% of its original tensile strength when tested according to ASTM D412 after being immersed in PmB-bitumen 25 (55-55a) for 168 hours at 200° C. according to ASTM D471; and/or
the ACM layer retains at least 30% of its original elongation at break when tested according to ASTM D412 after being immersed in PmB-bitumen 25 (55-55a) for 168 hours at 200° C. according to ASTM D471; and/or
the ACM layer exhibits a volume change of no greater than 50% after being immersed in PmB-bitumen 25 (55-55a) for 168 hours at 200° C. according to ASTM D471; and/or
the ACM layer exhibits a hardness change of no greater than 20 points when tested according to ASTM D2240 after being immersed in PmB-bitumen 25 (55-55a) for 168 hours at 200° C. according to ASTM D471.

6. The hose according to claim 5, wherein:
the ACM layer exhibits an original tensile strength of at least 7 MPa when tested according to ASTM D412; and/or
the ACM layer exhibits an original elongation at break of at least 200% when tested according to ASTM D412; and/or
the ACM layer exhibits an abrasion value of less than 200 mm³ when tested according to ASTM D5963; and/or
the ACM layer exhibits an ozone resistance of no cracking at 20% extension when tested after 168 hours at 50 pphm ozone at 40° C. according to ASTM D1149.

7. The hose according to claim 1, wherein:
the ACM-based elastomeric composition and the ECO-based elastomeric composition have the same type of plasticizer(s) and/or triazine cure system to promote compatibility and the direct bonding between layers.

8. The hose according to claim 2, wherein:
the at least one polymer of the ECO-based elastomeric composition further includes allyl glycidyl ether (AGE) monomer in addition to the epichlorohydrin (ECH) monomer, the chlorine cure sites being present on the ECH monomers of the at least one polymer, and the sulfur cure sites being present on the AGE monomers of the at least one polymer.

9. The hose according to claim 2,
further comprising a reinforcement layer that includes reinforcement strands;
wherein the ACM layer is an outer cover layer, the ECO layer is an intermediate layer inwardly of the ACM layer, and the NBR layer is an intermediate layer disposed inwardly of the ECO layer and outwardly of the reinforcement layer.

10. The hose according to claim 9, wherein:
the NBR layer is bonded to the reinforcement strands of the reinforcement layer.

11. The hose according to claim 10,
wherein the NBR layer is a first NBR layer,
the hose further comprising a second nitrile butadiene elastomer (NBR) layer bonded to the reinforcement strands on an opposite side of the reinforcement layer; and
the hose further comprising an inner tube layer defining a lumen of the hose, wherein the inner tube layer is directly bonded to the second NBR layer without an intervening adhesive layer;
wherein the inner tube layer is formed from a nitrile butadiene elastomer (NBR);
wherein the NBR of the inner tube layer is a different composition from the second NBR layer;
wherein the ACM cover layer, the ECO intermediate layer, the first NBR intermediate layer, the second NBR intermediate layer, and the NBR inner tube layer are co-cured together to form the direct bonding between layers and to form the hose without a post-cure.

12. The hose according to claim 1, wherein:
the triazine cure system of the ACM-based elastomeric composition and/or the triazine cure system of the ECO-based elastomeric composition is 2,4,6-trimercapto-1,3,5-triazine.

13. An asphalt and/or bitumen transfer system comprising:
a source of asphalt and/or bitumen; and
the hose according to claim 1 fluidly coupled to the source and configured to transfer the asphalt and/or bitumen.

14. A method of using an asphalt and/or bitumen transfer hose, comprising:
providing the hose according to claim 1; and
conveying asphalt and/or bitumen with the hose.

15. A method of manufacturing the multilayer hose according to claim 1, comprising:
applying the ECO-based elastomeric composition to form the ECO layer of the hose; and
applying the ACM-based elastomeric composition to form the ACM layer of the hose;
wherein the ECO layer and the ACM layer are in direct contact without an intervening adhesive layer therebetween; and
co-vulcanizing the ACM layer and the ECO layer, wherein the co-vulcanizing activates at least the chlorine cure sites with the triazine cure systems and directly bonds the ACM and ECO layers together.

16. A multilayer hose comprising:
an inner tube layer,
a reinforcement layer comprising reinforcement strands disposed outwardly of the inner tube layer,
a nitrile butadiene elastomer (NBR) layer bonded to the reinforcement strands, the NBR layer being formed from an NBR-based elastomeric composition comprising (i) one or more polymer(s) having acrylonitrile monomer and butadiene monomer; and (ii) a sulfur cure system;
an epichlorohydrin elastomer (ECO) layer directly bonded to the NBR layer without an intervening adhesive layer, the ECO elastomeric layer being formed from an ECO-based elastomeric composition comprising: (i) at least one polymer comprising epichlorohydrin monomer, in which the at least one polymer includes chlorine cure-sites and sulfur cure sites; and (ii) a triazine cure system that vulcanizes the ECO-based elastomeric composition via at least the chlorine cure-sites; and
a polyacrylic elastomer (ACM) layer directly bonded to the ECO layer without an intervening adhesive layer, the ACM elastomer layer being formed from an ACM-based elastomeric composition comprising: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites;
wherein co-vulcanization of the respective elastomeric compositions of the NBR layer, the ECO layer, and the ACM layer with their respective cure systems forms direct bonding between the NBR, ECO and ACM layers.

17. A method of manufacturing a multilayer hose, comprising:
applying a first elastomeric composition for forming an inner tube of the hose;
applying reinforcement comprising reinforcement strands around the first elastomeric composition for forming at least part of a reinforcement layer;
applying a second elastomeric composition for forming an intermediate layer around the reinforcement, wherein the second elastomeric composition is an epichlorohydrin elastomer (ECO) based elastomeric composition comprising: (i) at least one polymer comprising epichlorohydrin monomer, in which the at least one polymer includes chlorine cure-sites; and (ii) a triazine cure system that vulcanizes the ECO-based elastomeric composition via at least the chlorine cure-sites;
applying a third elastomeric composition for forming a cover layer around the intermediate layer, wherein the third elastomeric composition is a polyacrylic elastomer (ACM) based elastomeric composition comprising: (i) at least one polymer having one or more acrylate monomer(s), in which the at least one polymer includes chlorine cure-sites; and (ii) a triazine cure system that vulcanizes the ACM-based elastomeric composition via at least the chlorine cure-sites; and
co-vulcanizing the first, second, and third elastomeric compositions, wherein the co-vulcanizing activates at least the chlorine cure sites with the triazine cure systems of the ACM-based and ECO-based elastomeric compositions and directly bonds the intermediate layer and the cover layer together.

18. The method according to claim 17,
further comprising applying a fourth elastomeric composition after applying the reinforcement and before applying the second elastomeric composition for forming a second intermediate layer, the fourth elastomeric composition being a nitrile butadiene elastomer (NBR) based elastomeric composition comprising: one or more polymer(s) having acrylonitrile monomer and butadiene monomer; and a sulfur cure system;
wherein the at least one polymer of the ECO-based elastomeric composition includes sulfur cure sites in addition to the chlorine cure sites; and
wherein the co-vulcanizing includes co-vulcanizing the fourth elastomeric composition, and wherein the co-vulcanizing activates at least the sulfur cure sites of the ECO-based elastomeric composition with the sulfur cure system of the NBR-based elastomeric composition and directly bonds the intermediate layer and the second intermediate layer together.

19. The method according to claim 18,
further comprising applying a fifth elastomeric composition after applying the first elastomeric composition and before applying the reinforcement for forming a third intermediate layer, the fifth elastomeric composition being a nitrile butadiene elastomer (NBR) based elastomeric composition;
wherein the first elastomeric composition for forming the inner tube is an NBR-based elastomeric composition; and
wherein the co-vulcanizing includes co-vulcanizing the fifth elastomeric composition, and wherein the co-vulcanizing directly bonds the NBR-based elastomeric composition of the third intermediate layer to the NBR-based elastomeric composition of the inner tube layer.

20. The method according to claim 17, wherein
the applying of the first, second, third, fourth and/or fifth elastomeric compositions includes providing the respective elastomeric composition(s) in a band of material and spiral wrapping the band over the previous spiral-wrapped layer; and
wherein the applying the reinforcement includes providing the reinforcement as a calendered layer including the fourth and/or fifth elastomeric compositions on side(s) of the reinforcement, the applying includes providing the calendered layer as a band which is spiral wrapped over the previous spiral-wrapped layer.

21.-22. (canceled)
